(19) United States
(12) Patent Application Publication
(10) Pub. No.: US 2006/0196464 A1
(43) Pub. Date: Sep. 7, 2006

(54) External combustion rotary piston engine

(76) Inventor: James M. Conners, Listowel (CA)

Correspondence Address: Daniel B Schein, P O Box 28403, San Jose, CA, 95159, US

(21) Appl. No.: 10/541,482

(22) PCT Filed: Dec. 30, 2003
(86) PCT No.: PCT/CA03/02031

§ 371 Date: Mar. 10, 2006

Related U.S. Application Data
(60) Provisional application No. 60/438,764, filed on Jan. 9, 2003.

(51) Int. Cl. F02B 53/00; F02B 53/08; F02B 53/04

(52) U.S. Cl. 123/204; 123/213; 123/215

(57) ABSTRACT

An engine (400) is disclosed and comprises: a compressor (428) which periodically defines a chamber and carries out a pressurization process wherein the chamber volume is decreased to produce pressurized air; a combuster (426) which combusts fuel with the pressurized air to produce primary exhaust; an air motor (408) which is driven by the primary exhaust to produce power and secondary exhaust; an expander (410) which expands the secondary exhaust to produce tertiary exhaust and power; and a shaft (314) which directs power produced by the motor (408) and the expander (410) to the compressor (428) and any load. The combuster (426) is adapted to receive varying amounts of fuel, thereby to vary the power to the load. The compressor (428), during pressurization. releases air from the chamber such that the chamber pressure during pressurization and the primary exhaust pressure is substantially constant at steady state conditions, said constant being a function of the load being driven by the power.

### TECHNICAL FIELD

The following invention relates to engines, and more specifically, to variable compression engines.

### BACKGROUND ART

In a traditional piston-in-cylinder internal combustion engine, there are four “strokes”: intake; compression; power (expansion); and exhaust. In the intake stroke, the piston commences motion at a point proximal to the head of the cylinder and travels to a point distal to the head of the cylinder, creating an expanding void in the cylinder between the piston and the cylinder head which is suitably ported to atmosphere to fill with ambient air during such travel. At the end of the intake stroke, fluid communication between the atmosphere and the cylinder is arrested. In the compression stroke, the piston reverses direction in the cylinder, thereby compressing the air contained therein. When the air is highly compressed (at the end of the compression stroke) fuel mixed with the compressed air is ignited, to create combustion. In the power stroke, the piston is driven to a point distal to the head of the cylinder by the pressurized combustion products. In the exhaust stroke, the port to atmosphere is again opened, and the piston travels to the head of the cylinder, expelling the combustion products to the atmosphere as exhaust.

A problem common to this type of engine is that after the fuel burns, and the resulting hot gas drives the piston to the end of the power stroke, the temperature and pressure of the gas are still far above that of the surrounding atmosphere. This heat and pressure are both manifestations of wasted energy.

A further problem common to this type of engine derives from the fact that the pistons and connecting rods must reverse direction of motion many times a minute. The forces required to overcome the inertia involved require substantial engineering, and generate vibration and wear, leading to maintenance issues.

A further problem common to this type of engine is the efficiency losses associated with converting a reciprocating linear motion into rotational power. The connecting rod and crank gear reach their maximum angle for torque at about 75 degrees from top dead centre (“TDC”). Little useful work is done before 30 degrees from TDC or after 135 from TDC, so a considerable amount of efficiency is lost.

A yet further problem common to this type of engine is that the high combustion temperatures under which this engine operates result in relatively high NOx emissions.

This problem is exhibited, for example, in German Patent Application DE 25 50 360 A (England), which teaches a MULTIROTARY ENERGY CONVERSION VALVE. In this patent, it is taught to remove waste heat from the combustion gases using a heat exchanger 6a, to create steam in a boiler 20 using this waste heat, and to inject this steam into the outlet rotors 7, to contribute power. Peak combustion temperature will be a function of the initial temperature of the working fluid plus the temperature rise caused by the fuel combustion.

In U.S. Pat. No. 6,530,211 (Holtzapple et al.), issued Mar. 11, 2003, an engine is disclosed which comprises a compressor for ambient air, a combuster and an expander. The combuster receives fuel and burns same with the compressed air to produce exhaust gases. The expander receives the exhaust gases and expands them. The compressor may be a gerotor compressor or a piston compressor having variable-dead-volume control. The expander may be a gerotor expander or a piston expander having variable-dead-volume control. The combuster may be a tubular combuster. The gases exiting the expander are hot; some of the heat from such gases is removed by passage through a heat exchanger, which transfers the heat to the gases entering the combuster. The variable dead volume device consists of a piston in a cylinder. The position of the cylinder in the piston is set by an actuator, such as an electric servo motor. When the piston is moved to provide a small dead volume, the gases can reach high pressures. In contrast, when a large dead volume is provided, gas pressures remain low. Regulating the compression ratio in this manner allows the power output of the engine to be adjusted. As well, the gerotor configuration of this engine overcomes in part, the vibration and wear issues associated with piston-cylinder engines. However, the gerotors are difficult to fabricate. Further, the servos add complexity to the design, with attendant maintenance issues.

In U.S. Pat. No. 5,101,782 (Yang), issued Apr. 7, 1992, a rotary piston engine is disclosed. This engine includes two segregated compression and expansion chambers and one separate combustion chamber. In the compression and expansion chambers, a pair of screw-shaped rotors are mounted. In operation, the rotors in the compression chamber compress air. The compressed air is introduced, with fuel, to the combustion chamber, which is then closed, and the contents ignited, such that the fuel burns in a constant volume. The high pressure combustion products are then ported to the expansion chamber, which causes the rotation of a further pair of screw-shaped rotors, and the combustion products are cooled and exhausted. A portion of the heat removed from the combustion products is the same heat added to the compressed air.

This engine is indicated by its inventor to be characterized by high efficiency, high reliability and quiet operation. However, the need to employ screw-shaped rotors adds to cost, and the engine is prone to the production of high NOx emissions, resultant from the high temperatures employed.

### DISCLOSURE OF THE INVENTION

It is an object of the present invention to provide an engine which is relatively simple to fabricate, which is relatively efficient and reliable in operation and which produces relatively low NOx emissions. This object, amongst others, is met by the present invention, an engine for use with a load.

According to one aspect, the engine comprises a compressor, combuster means, a positive displacement air motor, a positive displacement gas expander and power transfer means.

The compressor is adapted to receive power and, upon receiving power, to: periodically define a chamber; fill the chamber with ambient air; and carry out a pressurization process wherein the chamber volume is decreased to produce pressurized air.

The combuster means is for receiving fuel and combusting same in a combustion process with the pressurized air to produce primary exhaust products.

The air motor is adapted to be driven by the primary exhaust products to produce power and secondary exhaust products.

The gas expander is for receiving the secondary exhaust products and expanding same substantially adiabatically to produce tertiary exhaust products and power.

The power transfer means is for directing power produced by the air motor and the gas expander in use to drive the compressor and the load.

The combuster means is adapted to receive varying amounts of fuel, thereby to cause the power transfer means to drive the load with varying amounts of power in use.

The combuster means is adapted to receive varying amounts of fuel, thereby to cause the power transfer means to drive the load with varying amounts of power in use.

The compressor and radiator are adapted to, during the pressurization process, release air from the chamber for said combustion in a manner such that the maximum pressure in the chamber during the pressurization process and the pressure of the primary exhaust products driving the air motor is substantially constant at steady state conditions, said constant being a function of the load being driven by the power. The compression ratio (CR) can be calculated using the following equation:
CR=(V1/V2)/(T2/T1), where

V1 represents the volume swept in the primary compression chamber, and

V2 represents the volume swept in the primary expansion chamber, and

T1 represents the ambient temperature (in ° K), and

T2 represents the temperature of the gases in the primary expansion chamber (in ° K).

The relative ratio of V1 versus V2 will determine the nominal minimum compression ratio of the engine. This is dictated by the geometry of the engine and will not vary. On the other hand, the difference between T1 and T2 will be due both to the temperature increase during compression, and due to the heat added by the fuel. When the engine is under a light load, less fuel will be needed, less heat will be generated and less work will be needed to run the compressor section. This variable compression ratio means that the engine will only do as much work compressing the incoming air as is required by torque demand of the engine, that is, the engine will spontaneously adjust its compression ratio to engine load, thereby to improve operating efficiency. Another consequence of this arrangement is that the combustion temperature at partial fuel loads will be lower than that at the maximum condition, so as to reduce the tendency of the engine to produce NOx emissions.

According to another aspect, the engine comprises a rotary compressor, a radiator, first and second backflow preventers, a pressure tank, a valve, a tubular combuster, a positive displacement rotary air motor, a positive displacement rotary gas expander and a shaft.

The compressor is adapted to receive power and, upon receiving power, to: periodically define a chamber; fill the chamber with ambient air; and carry out a pressurization process wherein the chamber volume is decreased to produce pressurized air.

The radiator is coupled to the compressor to receive the pressurized air and adapted to cool said pressurized air and to function as a reservoir therefor.

The first and second backflow preventers are each coupled to the radiator to permit unidirectional flow therefrom.

The pressure tank is coupled to the first backflow preventer to receive pressurized air from the radiator.

The valve is coupled to the pressure tank to permit the selective release of pressurized air from the pressure tank.

The combuster is coupled to the valve and to the second backflow preventer to receive pressurized air from the radiator and pressurized air selectively released from the pressure tank and adapted to receive fuel and combust same in a combustion process with the pressurized air so received to produce primary exhaust products.

The air motor is coupled to the combuster so as to be driven by the primary exhaust products to produce power and secondary exhaust products.

The gas expander is coupled to the air motor for receiving the secondary exhaust products and expanding same substantially adiabatically to produce tertiary exhaust products and power.

The shaft is operatively coupled to each of the compressor, the air motor and the gas expander for directing power produced by the air motor and the gas expander in use to drive the compressor and the load.

The combuster is adapted to receive varying amounts of fuel, thereby to cause the power transfer means to drive the load with varying amounts of power in use.

The compressor is adapted to, during the pressurization process, release air from the chamber for said combustion in a manner such that the maximum pressure in the chamber during the pressurization process and the pressure of the primary exhaust products driving the air motor is substantially constant at steady state conditions, said constant being a function of the load being driven by the power.

Two presently preferred embodiments of the present invention will now be described with reference to the attached drawings, which are hereinafter briefly described.

### BRIEF DESCRIPTION OF DRAWINGS

In the attached drawings, which are provided for illustration only, and are not meant in any way to limit the scope of the present invention:

FIG. 1 is a schematic overview of an engine according to the first preferred embodiment of the present invention;

FIG. 2 is a front view of an engine according to the first preferred embodiment of the present invention;

FIG. 3 is a cross-section of the engine of FIG. 2 viewed along line 3-3 of FIG. 2;

FIG. 4 is a front cross-sectional view of the engine of FIG. 2, taken in the location of line 4-4 of FIG. 3;

FIG. 5 is a front cross-sectional view of the engine of FIG. 2, taken in the location of line 5-5 of FIG. 3;

FIG. 5a is a cross-sectional view along lines 5a-5a of FIG. 5;

FIG. 6 is a front cross-sectional view of the engine of FIG. 2, taken in the location of line 6-6 of FIG. 3;

FIG. 7 is a front cross-sectional view of the engine of FIG. 2, taken in the location of line 7-7 of FIG. 3;

FIG. 8 is a front cross-sectional view of the engine of FIG. 2, taken in the location of line 8-8 of FIG. 3;

FIG. 9 is a front cross-sectional view of the engine of FIG. 2, taken in the location of line 9-9 of FIG. 3;

FIG. 10 is a front cross-sectional view of the engine of FIG. 2, taken in the location of line 10-10 of FIG. 3;

FIG. 11a is a side view of a tubular combuster of the engine of FIG. 2;

FIG. 11b is a front view of the tubular combuster of FIG. 11a;

FIG. 11c is a side cross-sectional view of the tubular combuster of FIG. 11a;

FIG. 11d is a cross section of the tubular combuster of FIG. 11a;

FIG. 12a is a front view of an assembled piston of the engine of FIG. 2;

FIG. 12b is a side cross-sectional view of the piston of FIG. 12a along line 12b-12b of FIG. 12a;

FIG. 12c is a top view of the piston of FIG. 12a;

FIG. 13a is a front view of a piston body of the piston of FIG. 12;

FIG. 13b is a side cross-sectional view of the piston body of FIG. 13a, taken along line 13b-13b of FIG. 13a;

FIG. 13c is a top view of the piston body of FIG. 13a;

FIG. 14a is a front view of a lobe face seal of the piston of FIG. 12a;

FIG. 14b is a rear view of the lobe face seal of FIG. 14a;

FIG. 14c is a top view of the lobe face seal of FIG. 14a;

FIG. 15a is a side view of a piston side seal of the piston of FIG. 12a;

FIG. 15b is a front view of the piston side seal of FIG. 15a;

FIG. 16a is a front view of a lobe tip seal of the piston of FIG. 12;

FIG. 16b is a top view of the lobe tip seal of FIG. 16a;

FIG. 16c is a side view of the lobe tip seal of FIG. 16b;

FIG. 17a is a front view of a piston face seal of the piston of FIG. 12a;

FIG. 17b is a side view of the piston face seal of FIG. 17a;

FIG. 18a is a front view of a lobe of the piston of FIG. 12a;

FIG. 18b is a side cross-sectional view of the lobe of FIG. 18a, taken along line 18b-18b of FIG. 18a;

FIG. 18c is a top view of the lobe of FIG. 18a;

FIG. 19a is a front view of a gate rotor of the engine of FIG. 2;

FIG. 19b is a side view of the gate rotor of FIG. 19a;

FIG. 19c is a front view of a gate rotor face seal of the gate rotor of FIG. 19a;

FIG. 19d is a side view of the gate rotor face seal of FIG. 19c;

FIG. 19e is a top view of a socket seal of the rotor of FIG. 19a;

FIG. 19f is a front view of the socket seal of FIG. 19e;

FIG. 19g is a front view of a gate rotor body of the gate rotor of FIG. 19a;

FIG. 19h is a side cross-sectional view of the gate rotor body of FIG. 19g;

FIG. 19i is a side view of a gate rotor side seal of the rotor of FIG. 19a;

FIG. 19j is a front view of the gate rotor side seal of FIG. 19i;

FIG. 20a is a front view of the fuel pump of FIG. 2, with a cover plate removed;

FIG. 20b is a side view of the cover plate of FIG. 2;

FIG. 20c is a rear view of the cover plate of FIG. 20b;

FIG. 20d is a side view of a pump block of FIG. 20a;

FIG. 20e is a cross section of the pump block of FIG. 20d;

FIG. 20f is a front view of the pump block of FIG. 20d;

FIG. 20g is a side view of a throttle shaft of the fuel pump of FIG. 2;

FIG. 20h is a front view of the throttle shaft of FIG. 20g;

FIG. 20i is a front view of the end plate of FIG. 20a;

FIG. 20j is a side view of the end plate of FIG. 20i;

FIG. 20k is a side view of a pump vane of the pump of FIG. 2;

FIG. 20l is a front view of the pump vane of FIG. 20k;

FIG. 20m is a front view of a pump rotor of the pump of FIG. 2;

FIG. 20n is a side view of the pump rotor of FIG. 20m;

FIG. 20o is a side view of the throttle slide of FIG. 20a;

FIG. 20p is a front view of the throttle slide of FIG. 20a;

FIG. 21 is a schematic overview of an engine according to the second preferred embodiment of the present invention;

FIG. 22 is a rear view of an engine constructed according to the second preferred embodiment;

FIG. 23 is a side cross-sectional view taken along line 23-23 of FIG. 22:

FIG. 24 is a front cross-sectional view taken in the location of lines 24-24 of FIG. 23;

FIG. 25 is a front cross-sectional view taken in the location of lines 25-25 of FIG. 23; and

FIG. 26 is a front cross-sectional view taken in the location of lines 26-26 of FIG. 23.

### BEST MODES FOR CARRYING OUT THE INVENTION

As will become evident upon a review of the following description, a rotary fluid pressure device forms the basic structure of a number of the components of the two engines described hereinafter as preferred embodiments of the invention. Accordingly, for clarity in such following description, the basic structure of an exemplary rotary device and the operation thereof shall firstly be detailed.

Rotary Device

An exemplary rotary device 200B is shown in FIG. 6 and should be understood to comprise a multilobe piston 204B and a pair of gate rotors 206B.

In addition, the rotary device 200B comprises housing means for defining a pair of fluid ports 208B,210B and a piston chamber 212B in fluid communication with each of the fluid ports 208B,210B.

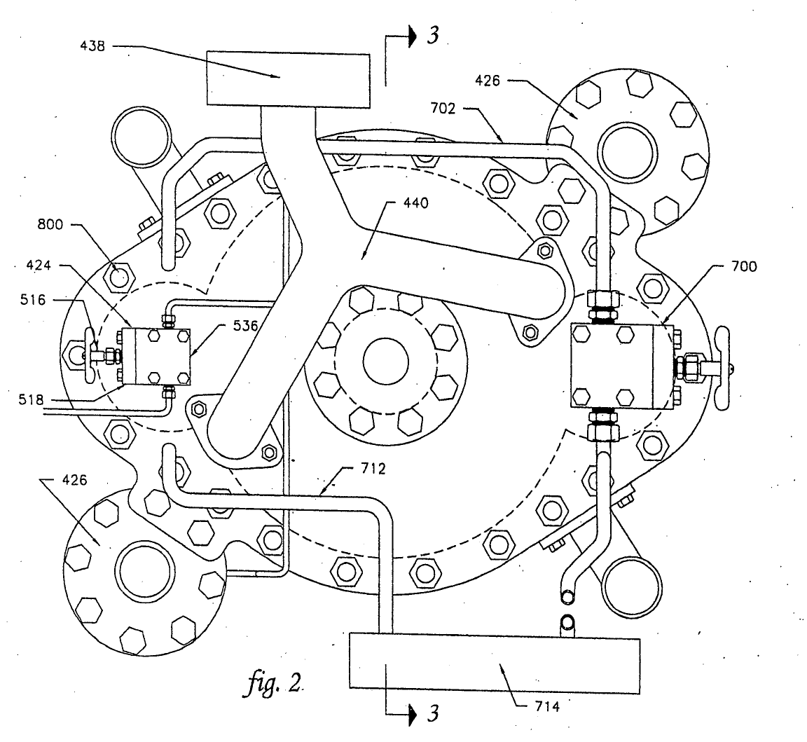

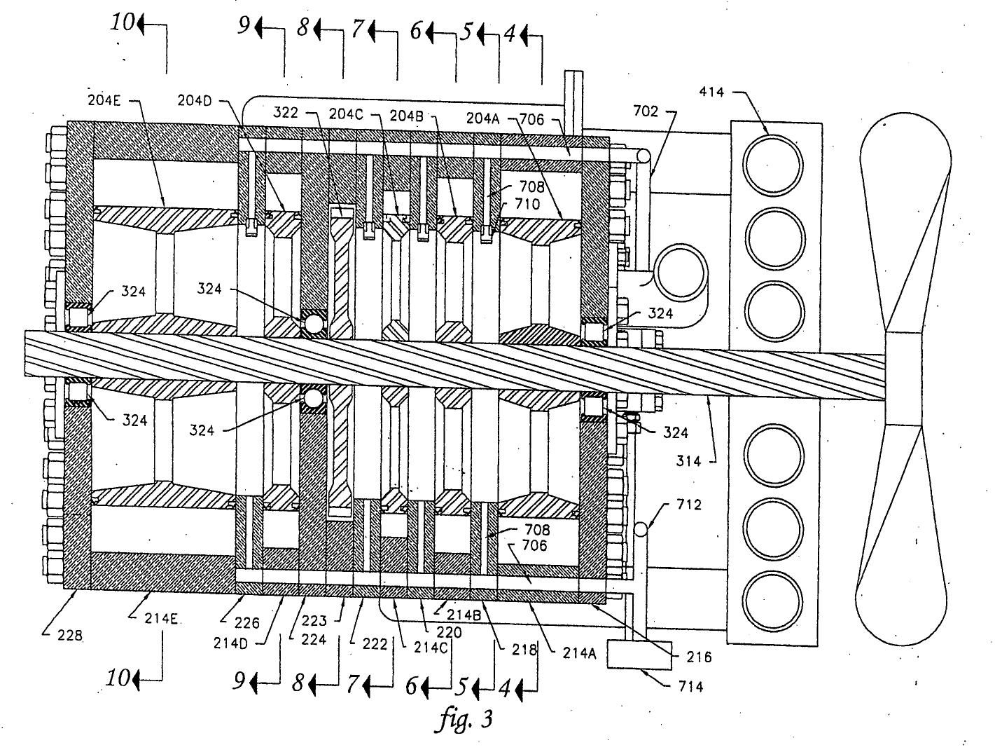

The housing means, for example, can comprise a housing plate 214B and a pair of divider plates 218,220 stacked on opposite sides thereof, as shown in FIG. 3, wherein the housing plate 214B has a cut-out which, in combination with the abutting divider plates 218,220, defines the piston chamber 212B, and wherein the fluid ports 208B,210B are defined in the divider plates 218,220.

In FIG. 6, a pair of fluid ports 210B are shown in abutting divider plate 220. Fluid ports 208B in this exemplary rotary device 200B are formed in divider plate 218. As this plate is not visible in FIG. 6, for clarity, the location of such fluid ports 208B in abutting divider plate 218 is demarcated in dotted outline.

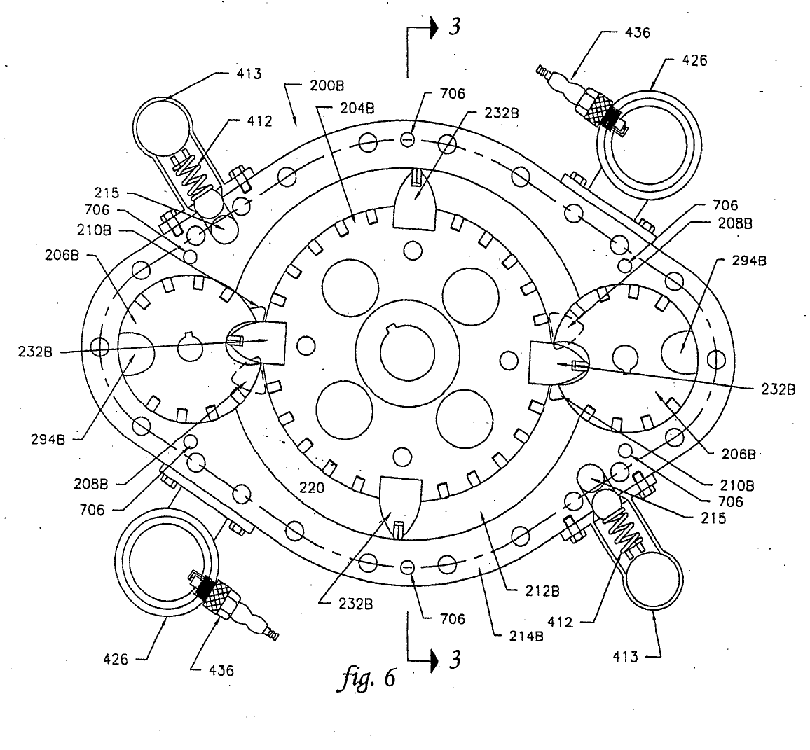

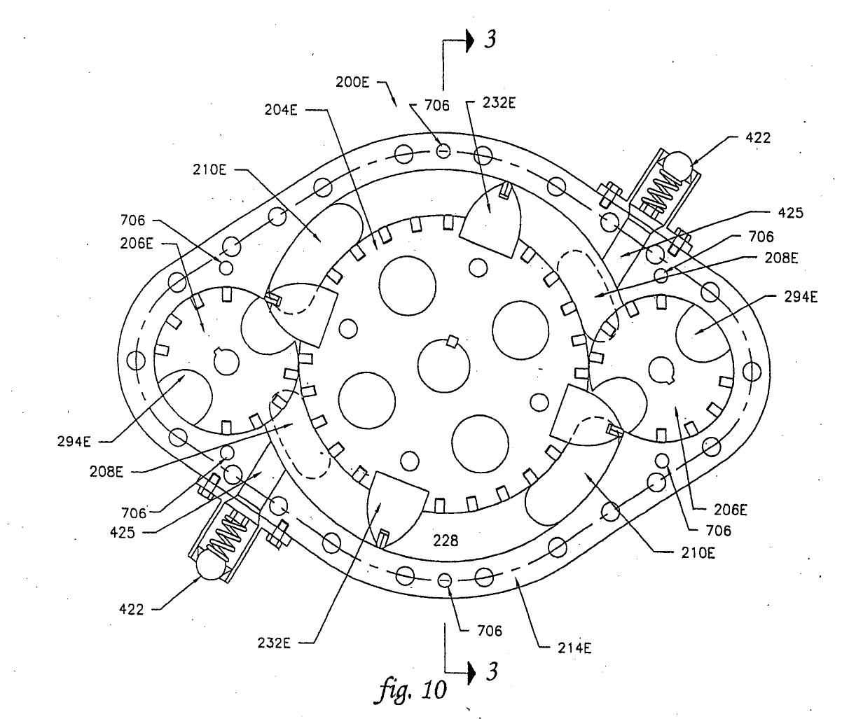

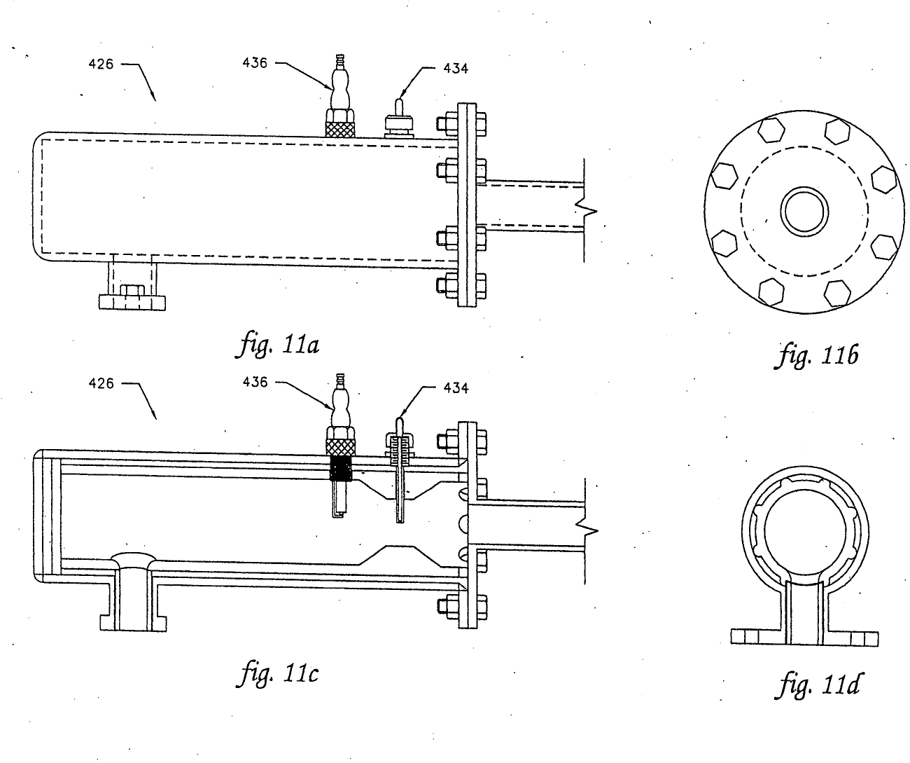

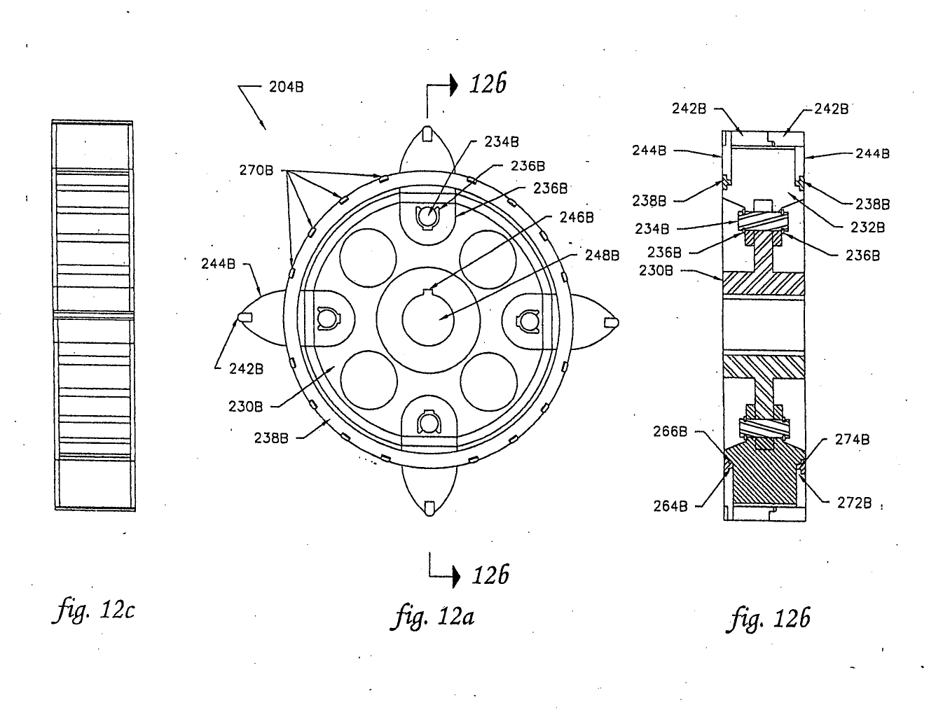

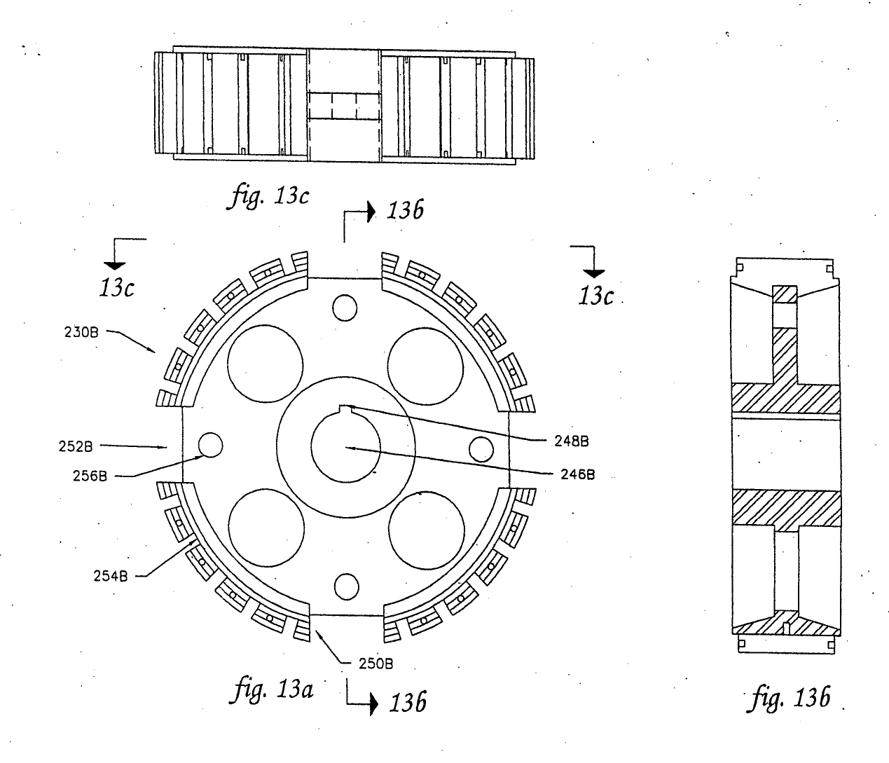

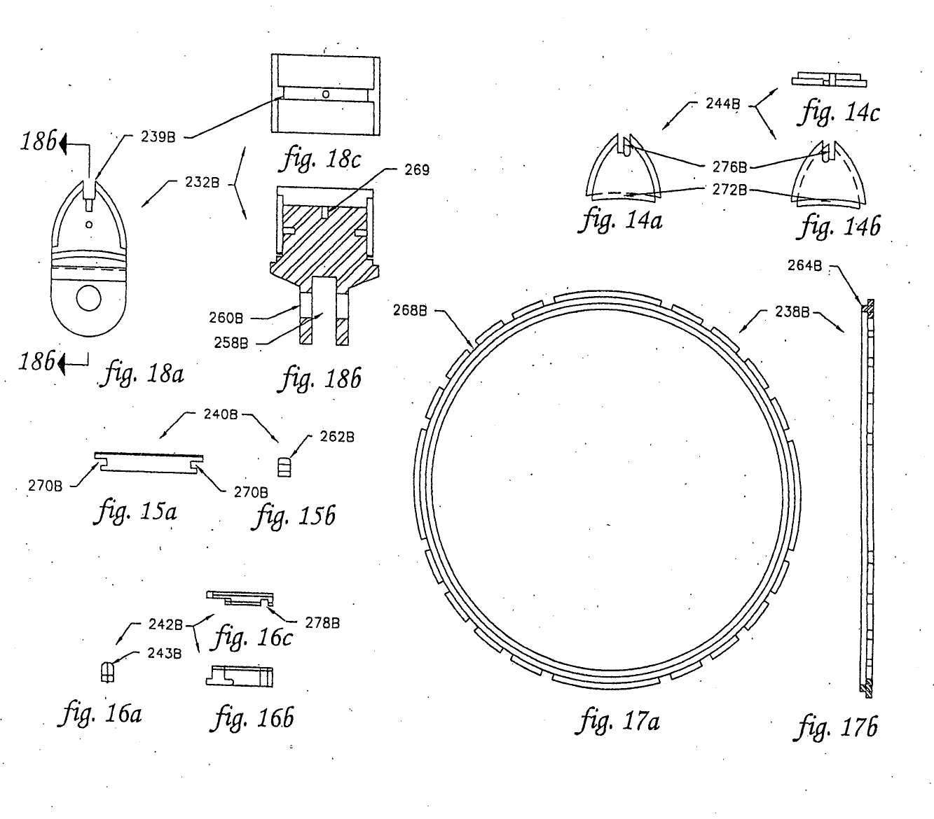

With general reference to FIGS. 12a-17b, the piston 204B comprises a piston body 230B, lobe bodies 232B, pins 234B, retaining clips 236B, piston face seals 238B, piston side seals 240B, lobe tip seals 242B and lobe face seals 244B.

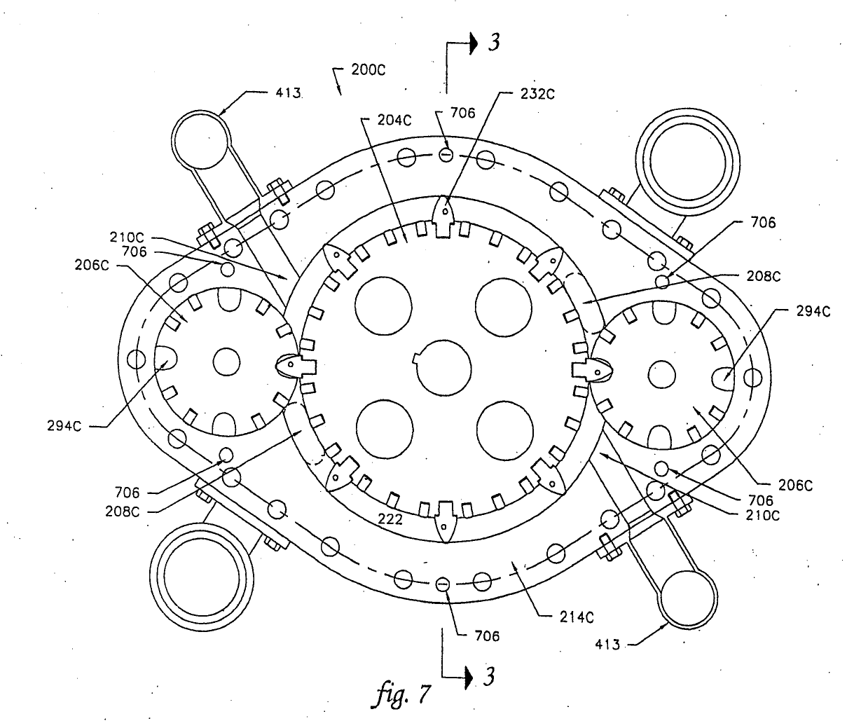

As best illustrated in FIG. 13a, the piston body 230B is generally annular and includes a central bore 246B for receipt of a notched shaft (not shown) and a keyway 248B for securing the shaft and piston body 230B together by way of a key (not shown). The piston body 230B further has a peripheral toothed portion 250B disposed on each quadrant, in spaced relation to one another to define four gaps 252B. Each toothed portion 250B defines five interstices 254B. Bores 256B are provided through the piston body 230B, adjacent the gaps 252B.

With reference to FIGS. 13a and 18a, the lobe bodies 232B are provided one for each gap 252B, and each has a bifurcated base 258B which is fitted in close-fitting relation into said each gap 252B in straddling relation to the piston body 230B. A pin passage 260B is defined through the base 258B which is aligned with a respective bore 256B. Each lobe body 232B is provided with a notch 239B at its tip. Each lobe body 232B defines a lobe of the multilobe piston 204B.

The pins 234B are provided one for each pin passage 260B. Each pin 234B passes through the pin passage 260B for which it is provided and the aligned bore 256B, and is secured in place by a pair of retaining clips 236B, as seen in FIGS. 12a and 12b.

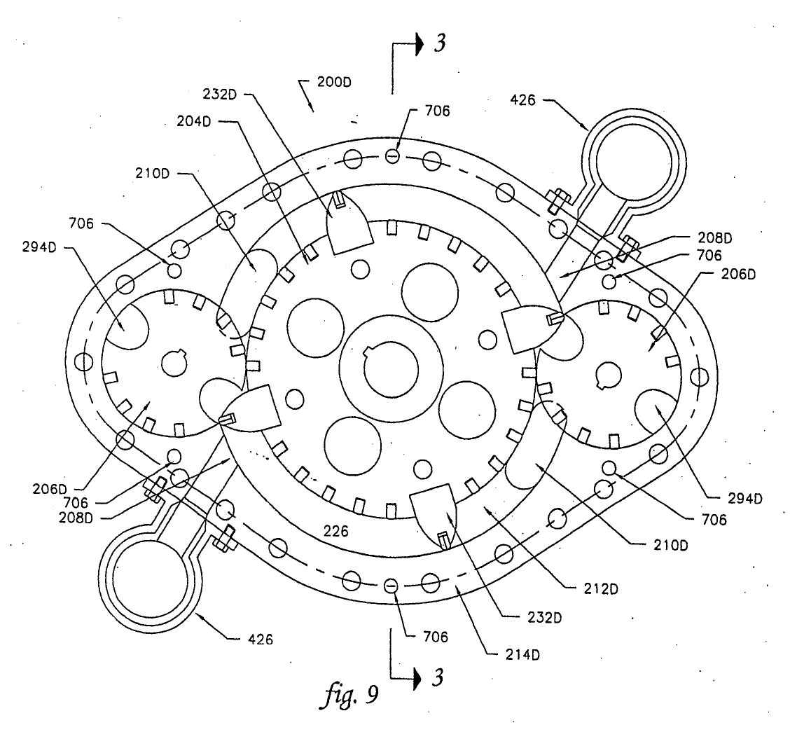

The piston side seals 240B, shown in FIGS. 15a and 15b, are disposed one into each interstice 254B, have respective chamfered surfaces 262B presenting radially outwardly and protruding end portions 270B.

The piston face seals 238B are disposed one on each faces of the piston body 230B/lobe 232B assembly, as shown in FIG. 12B. Each piston face seal 238B has a ridge 264B which fits into a corresponding recess 266B which is defined by the piston body 230B, lobe bodies 232B and piston side seals 240B. Each piston face seal 238B further has a plurality of notches 268B, best seen in FIG. 17a, which are in receipt of the protruding ends 270B of the piston side seals 240B, as shown in FIG. 12b.

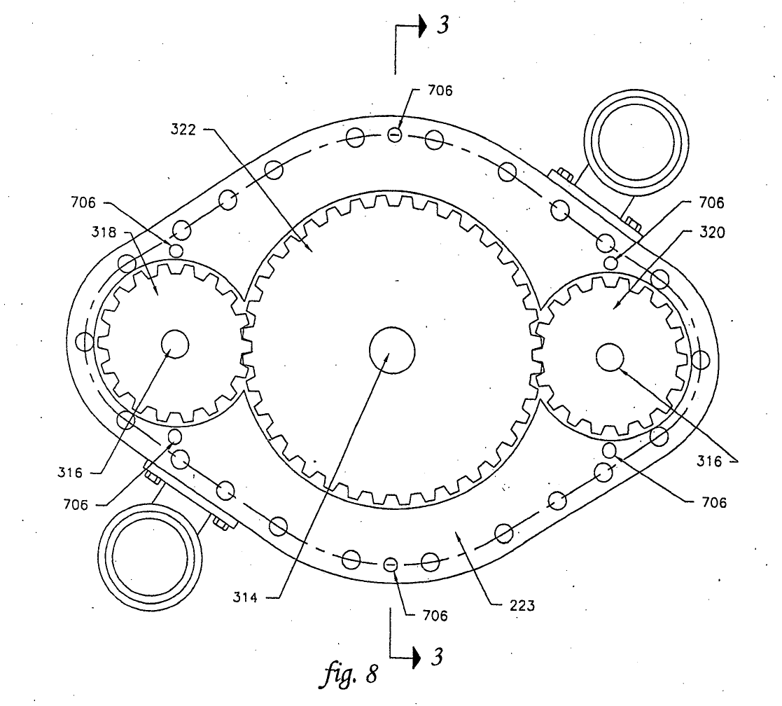

The lobe face seals 244B are disposed, one each, on opposite faces of each lobe 232B, as shown in FIG. 12b. Each lobe face seal 244B has a tongue portion 272B which fits into a groove 274B defined by the piston face seals 238B and the lobes 232B. Each lobe face seal 244B further has a notch 276B defined at its tip, as shown in FIGS. 14a,14b which aligns with the notch 239B at the tip of the lobe 232B.

A pair of lobe tip seals 242B is provided for each lobe 232B. Each lobe tip seal 242B is fitted in locking relation into the aligned notches 2398, 276B, and the pair of lobe tip seals 242B are locked relative to one another by notch/detents 278B defined thereon. The lobe tip seals 242B have respective chamfered surfaces 243B presenting radially outwardly.

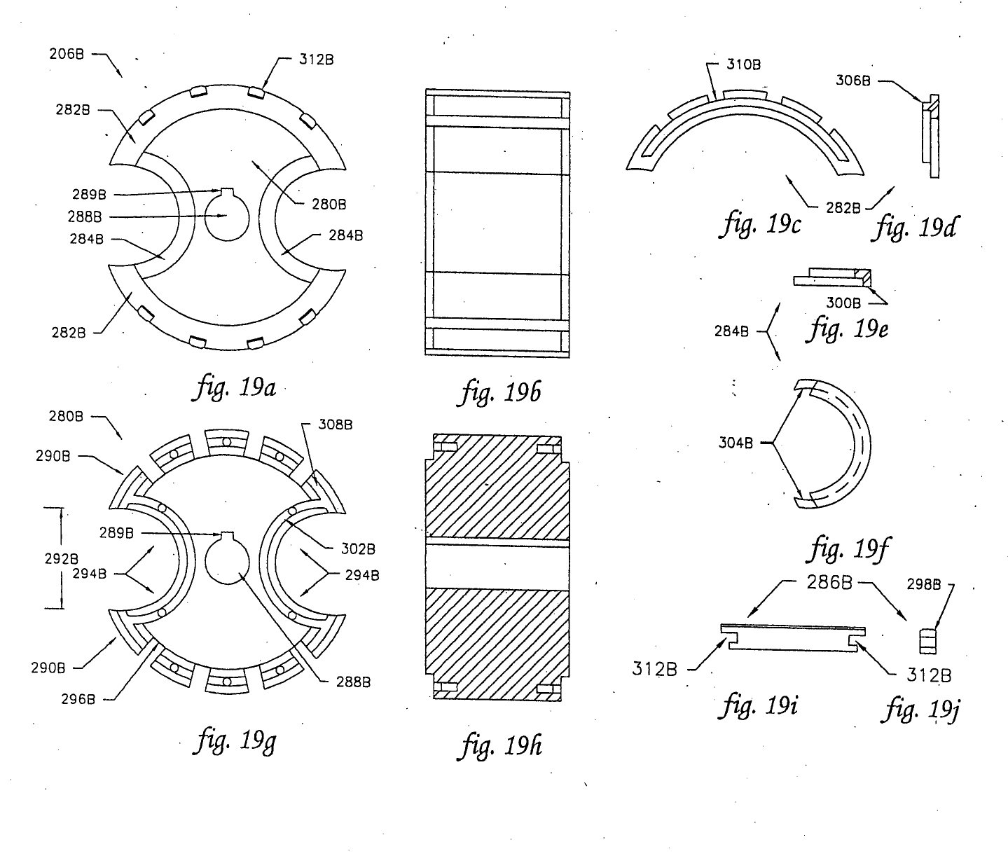

With reference to FIGS. 19a-19j, each gate rotor 206B comprises a gate rotor body 280B, gate rotor face seals 282B, socket seals 284B and gate rotor side seals 286B.

The gate rotor body 280B is seen in FIG. 19g to be generally annular and to include a central bore 288B for receipt of a notched shaft (not shown) and a keyway 289B for securing the shaft and gate rotor body 280B together by way of a key (not shown).

The gate rotor body 280B has a pair of peripheral toothed portions 290B, disposed opposite and in spaced relation to one another to define gaps 292B. Sockets 294B are formed in the gaps 292B. Each toothed portion 290B defines four interstices 296B.

The gate rotor side seals 286B, shown in FIGS. 19i, 19j, are disposed one each in the interstices 296B, have respective chamfered surfaces 298B presenting radially outwardly and projecting end portions 312B.

A socket seal 284B, shown in FIGS. 19e,19f is disposed on each face of each socket 294B and has a ridge 300B which fits into a corresponding groove 302B defined by the gate rotor body 280B, as seen in FIG. 19g. The socket seal 284B also has projecting end portions 304B, identified in FIG. 19f.

A gate rotor face seal 282B, shown in FIG. 19c, is disposed on each side of each toothed portion 290B, in overlying relation to the projecting portions 304B of adjacent socket seals 284B, has a ridge 306B which is fitted into a corresponding groove 308B defined by the gate rotor body 280B, shown in FIG. 19g, and a plurality of notches 310B which receive the protruding ends 312B of the gate rotor side seals 286B, as shown in FIG. 19a.

In both the gate rotors 206B and piston 204B, a plurality of recesses 269 are provided. One recess 269 is identified in FIG. 18b. A respective spring (not shown) is fitted into each recess 269. This serves to ensure that the seals 238B, 240B, 242B, 244B, 282B, 284B and 286B float above adjacent portions of the piston body 230B, lobes 232B and gate rotor body 280B, to ensure sealing contact with adjacent structures.

In use, the piston 204B is mounted in said piston chamber 212B on a rotatable drive shaft 314. This provides for rotation of one of said piston 204B and said drive shaft 314 upon rotation of the other. The piston 204B is mounted such that the lobe tip seals 242B sweep the inner surface of the piston chamber 212B.

The gate rotors 206B are each mounted in said piston chamber 212B, on a respective rotatable gate rotor shaft 316 aligned parallel to the drive shaft 314 and 180° apart from one another relative thereto, in sealing contact against the piston 204B and against the inner surface of the piston chamber 212B. Further, the pair of gate rotors 206B are coupled to said piston 204B to provide for rotation of one of said piston 204B and said gate rotors 206B upon rotation of the other, by means of a gear set 318,320,322 coupled to the drive shaft 314 and gate rotor shafts 316 and shown in FIG. 8. The gear set has a 2:1 ratio, such that for each rotation of primary gear 322, secondary gears 318,320 rotate twice.

The piston 204B and the gate rotors 206B divide the piston chamber 212B into multiple, specifically, two, subchambers of changing volume as the piston 204B and gate rotors 206B rotate, said subchambers each being in communication with one of the fluid ports 208B and one of the fluid ports 210B in a manner which permits operation of the device 200B either in the manner of a compressor, upon coupling the fluid ports 208B to a source of fluid to be compressed and coupling the drive shaft 314 to a motive source, or as an expander, upon coupling fluid ports 208B to a source of fluid to be expanded, in which case, the drive shaft 314 may be coupled to a load.

For further clarification as to such operation, consider two adjacent lobes 232B on the piston 204B.

When in use as a compressor, the piston 204B rotates counterclockwise, in the view of FIG. 6. As the first or preceding lobe 232B sweeps past a respective fluid port 208B, available gas, such as ambient air, is pulled into the expanding space behind said lobe 232B. Once the following lobe passes beyond said fluid port 208B, the gas within this initial volume is trapped. The boundaries of the enclosed annular space include the back side of the preceding lobe 232B, the abutting divider plates 218,220, the housing plate 214B and the piston 204B, and the front face of the following lobe 232B. After the preceding lobe 232B articulates with a socket 294B in a respective gate rotor 206B, the gate rotor 206B defines one end of the enclosed space. As the piston 204B continues to rotate, the enclosed space decreases in volume, thereby forcing the trapped air through fluid port 210B. It is notable that this enclosed space remains in communication with fluid port 210B as it decreases in volume.

Alternatively, when in use as an expander, incoming gases act on the back faces of the lobes 232B on the piston 204B, thereby exerting a force on the piston 204B; the front faces sweep out expanded gases.

### First Preferred Embodiment

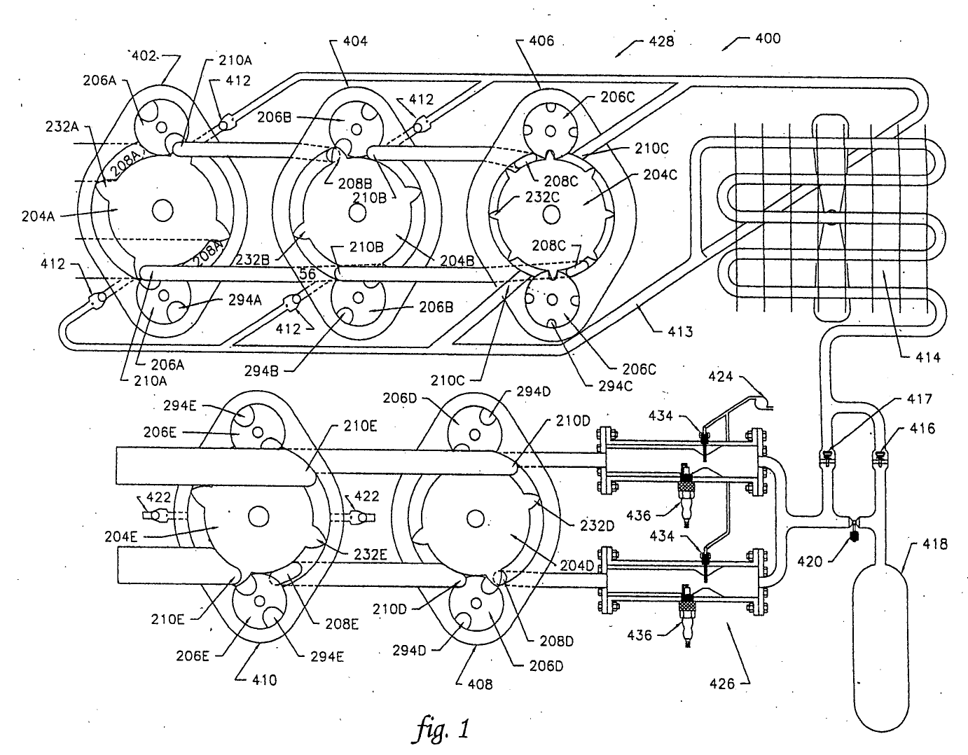

Turning now to the engine 400 constructed according to the aforementioned first preferred embodiment, a schematic overview of same is shown as FIG. 1.

From the overview, this engine 400 will be seen to comprise a first compression stage 402, a second compression stage 404, a third compression stage 406, a positive displacement air motor 408 and a positive displacement gas expander 410. Each of these elements take the form of a rotary device as previously described, and in fact, the exemplary rotary device described is one and the same as that of the second compression stage 404. As these rotary devices are generally similar in operation and structure, a detailed description of each is not provided herein. Rather, it should simply be understood that equivalent structures in each of the rotary devices share a common numeric identifier, and that the alphabetic identifier of the structures denote the device in question, as follows: first compression stage (A), second compression stage (B), third compression stage (C), air motor (D) and gas expander (E). Thus, since the housing plate in the example was identified with the reference numeral 214B, the housing plate for the air motor is 214D. Similarly, since the piston in the example was identified with 204B, the piston for the third compression stage 406 is identified 204C.

In addition, it should be presently understood that each of these elements share a common drive shaft 314 and gate rotor shafts 316, and further, share divider and bearing plates 216,218,220, 222, 223, 224, 226, 228, in the context of adjacent rotary devices. Thus, the housing means of the rotary device 200A of the first compression stage 402 is defined by bearing plate 216, divider plate 218 and housing plate 214A. Divider plate 218 also forms part of the housing means of the rotary device 200B of the second compression stage 404, in combination with divider plate 220 and housing plate 214B. Divider plate 220, divider plate 222 and housing plate 214C form the housing means of the rotary device 200C of the third compression stage 406. Bearing plate 224, housing plate 214D and divider plate 226 form the housing means of the rotary device 200D of the air motor 408. Similarly, housing plate 226, housing plate 214E and bearing plate 228 form the housing means of the rotary device 200D of the gas expander 410. For clarity, bearing plates 216,224 and 228 include bearings 324 for rotatably supporting the drive shaft 314. Only housing plate 218 is shown in detail in the drawings, but it should be understood that the other housing plates 220,222 and 226 are substantially similar thereto, differing substantially only in the size and shape of ports therein. The construction of such bearing plates 220,222 and 226 will be routine to persons of ordinary skill in the art, having regard, inter alia, to the demarcation of the ports 208,210 in FIGS. 4,6,7,9 and 10. Bolts 800, shown in FIG. 2, secure the assembly together.

From the overview, the engine will further be seen to comprise two sets of check valves 412, a manifold 413, a radiator 414, a pair of back-flow preventers 416,417, a pressure tank 418, a solenoid valve 420, a pair of vacuum relief valves 422, a fuel pump 424 and a tandem tubular combuster 426.

With reference to FIGS. 3 and 4, the rotary device 200A of the first compression stage 402 operates as a compressor, and its piston 204A has four lobes 232A. With reference to FIGS. 3 and 6, the rotary device 200B of the second compression stage 404 also operates as a compressor, with its piston 204B having four lobes 232B, but differs, in that its piston 204B is thinner and its lobes 232B are smaller than in the first compression stage 402. The piston 204B also has a diameter smaller than the diameter of the piston 204A in the first compression stage 402. With reference to FIGS. 3 and 7, the rotary device 200C of the third compression stage 406 also is configured for operation as a compressor. However, in contrast the pistons 204A,204B of the first 402 and second 404 compression stages, this piston 204C has eight lobes 232C, and is even thinner than the piston 204B of the second compression stage 404. Further, the gate rotors 206C of the third compression stage 406 each have four sockets 294C, in contrast to the pairs of sockets 294A,294B formed in the gate rotors 206A, 206B of the first 402 and second 404 compression stages.

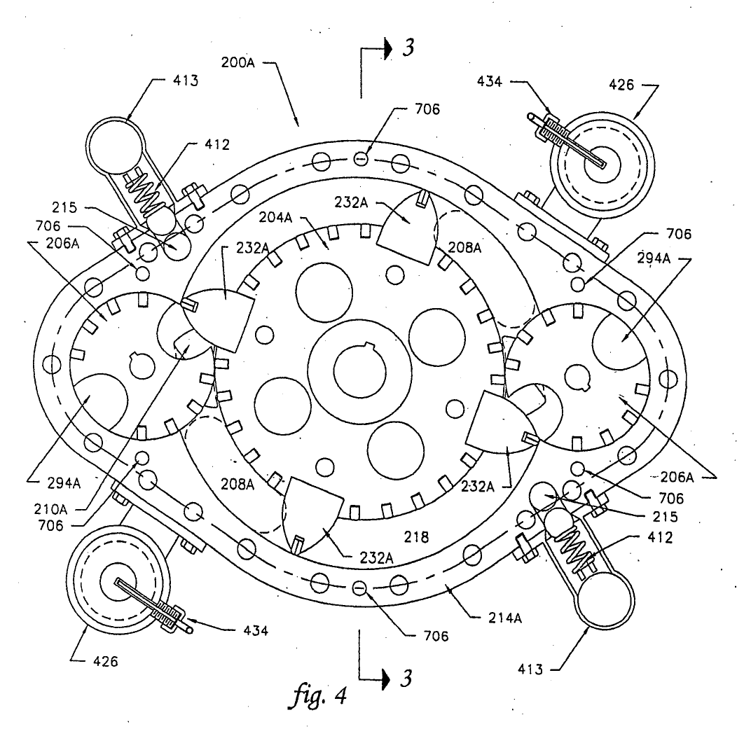

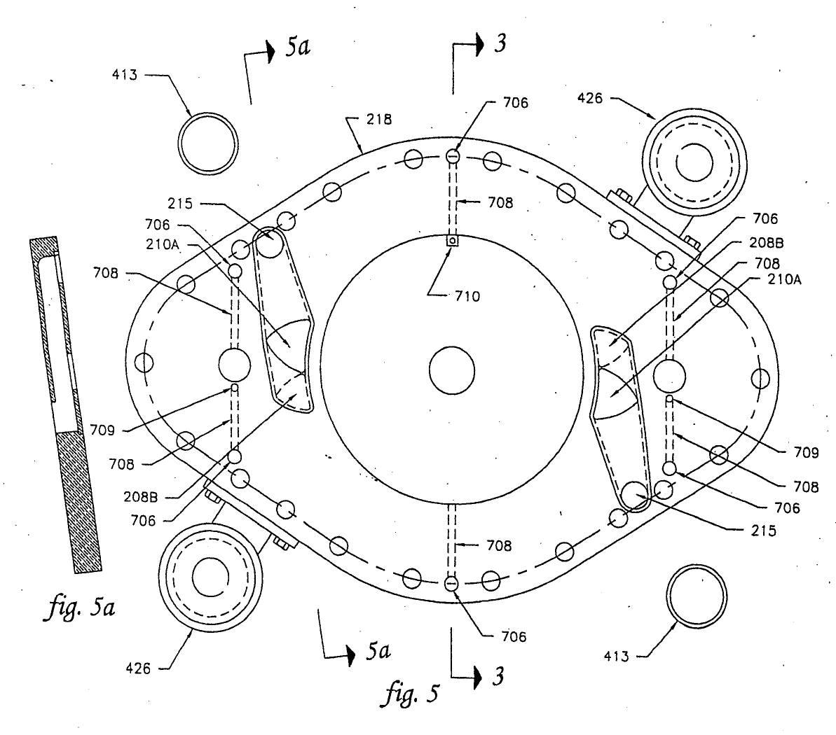

The first 402, second 404 and third 406 compression stages together define a compressor 428, identified in FIG. 1, that is adapted to receive power from the drive shaft 314 and, upon receiving power, to: periodically define a chamber; fill the chamber with ambient air; and carry out a pressurization process wherein the chamber volume is decreased to produce pressurized air. More particularly, the inlets 208A of the first compression stage 402 are coupled to an air filter 438 by means of a bifurcated intake duct 440 to receive filtered ambient air, as shown in FIG. 2; the outlets 210A of the first compression stage 402 are coupled to the inlets 208B of the second compression stage 404, as shown in FIG. 1 and FIG. 5; and the outlets 210B of the second compression stage 404 are coupled to the inlets 208C of the third compression stage 406, as shown in FIG. 1. This provides a direct flow path from the inlets 208A of the first compression stage 402, which receive ambient air, to the outlets 210C of the third compression stage 406, which deliver air to the manifold 213. It is noted at this time that the chamber defined periodically by the compressor 428 is defined initially by the first compression stage 402, and thereafter, by the second 404 and third 406 compression stages, as it decreases in volume.

The use of a staged compression is advantageous, as is readily understood by persons of ordinary skill in the art, since it lessens the pressure differential faced by any single stage, and thereby greatly facilitates the manner of sealing.

The check valves 412 are coupled to the outlets 210A, 210B of each of the first 402 and second 404 compression stages, as shown in schematic form in FIG. 1. The manner of such coupling in this preferred embodiment will be readily understood from a review of FIG. 5 and FIG. 6. FIG. 5 shows divider plate 218, and shows two passages, each leading between a respective port 208B and port 210A. Two additional passages are shown, each leading between port 210A and port 215. Ports 215, in turn, are shown in FIG. 6 to lead to the manifold 413 through respective check valves 412. Ports 215 are also shown in FIG. 4, and function similarly. Such coupling of the check valves 412 to the manifold 413 provides an alternate flow path, if the pressure in the manifold 413 is less than the pressure at the outlets 210A,210B. That is, some portion of the gas exiting the outlet 210A of the first compression stage 402 will pass into the manifold 413 if of higher pressure than the contents of the manifold 413. Similarly, some portion of the gas exiting the outlet 210B of the second compression stage 404 will pass into the manifold 413 if of higher pressure than the contents of the manifold 413. The check valves 412 of this preferred embodiment are of the simple spring-biased ball-in-socket variety well-known to persons of ordinary skill in the art, and as such, are not described in detail herein.

With reference to FIG. 1, the radiator 414 is coupled to the manifold 413 to receive air therefrom, and is a vessel of high surface area relative to its volume which is adapted to permit heat generated in the course of pressurization to be transferred to ambient air. Importantly, the radiator 414 also functions as a reservoir of cooled pressurized air.

The first backflow preventer 416 and the second backflow preventer 417 are each coupled to the radiator 414 to permit unidirectional flow therefrom.

The pressure tank 418 is coupled to the first backflow preventer 416 to receive pressurized air from the radiator 414.

The solenoid valve 420 is coupled to the pressure tank 418 to permit the selective release of cooled pressurized air from the pressure tank 418.

With reference to FIGS. 1 and 11a-d, the tubular combuster 426 is coupled to the solenoid valve 420 and to the second backflow preventer 417 to receive pressurized air from the radiator 414 and pressurized air selectively released from the pressure tank 418 and is adapted to receive fuel and combust same in a combustion process with the pressurized air so received to produce primary exhaust products. Thus, the tubular combuster 426 defines combuster means for receiving fuel and combusting same in a combustion process with the pressurized air to produce primary exhaust products. In the preferred embodiment illustrated, the tubular combuster 426 is a ceramic lined tubular combuster. The construction of tubular combusters is known to persons of ordinary skill in the art and as such is not detailed herein. In the tubular combuster 426, fuel is introduced via fuel injectors 434, and combustion is initiated by an igniter 436, which takes the form of a conventional spark plug.

The fuel pump 424 of this preferred embodiment of the engine 400 has specific characteristics which provide for effective operation of the engine 400. Firstly, the fuel pump 424 provides the fuel to the fuel injectors 434 substantially continuously, to provide for a substantially constant pressure burn. Further, it is synchronized with the drive shaft 314 to provide a fixed volume of fuel to the combuster 426 for each revolution for a given steady state load and is capable of increasing or decreasing this volume to meet changes in loading. Yet further, it delivers a uniform flow at sufficient pressure to achieve atomization even when flow rates are very low. As well, it is capable of handling fuels that have little or no lubricating properties such as alcohol.

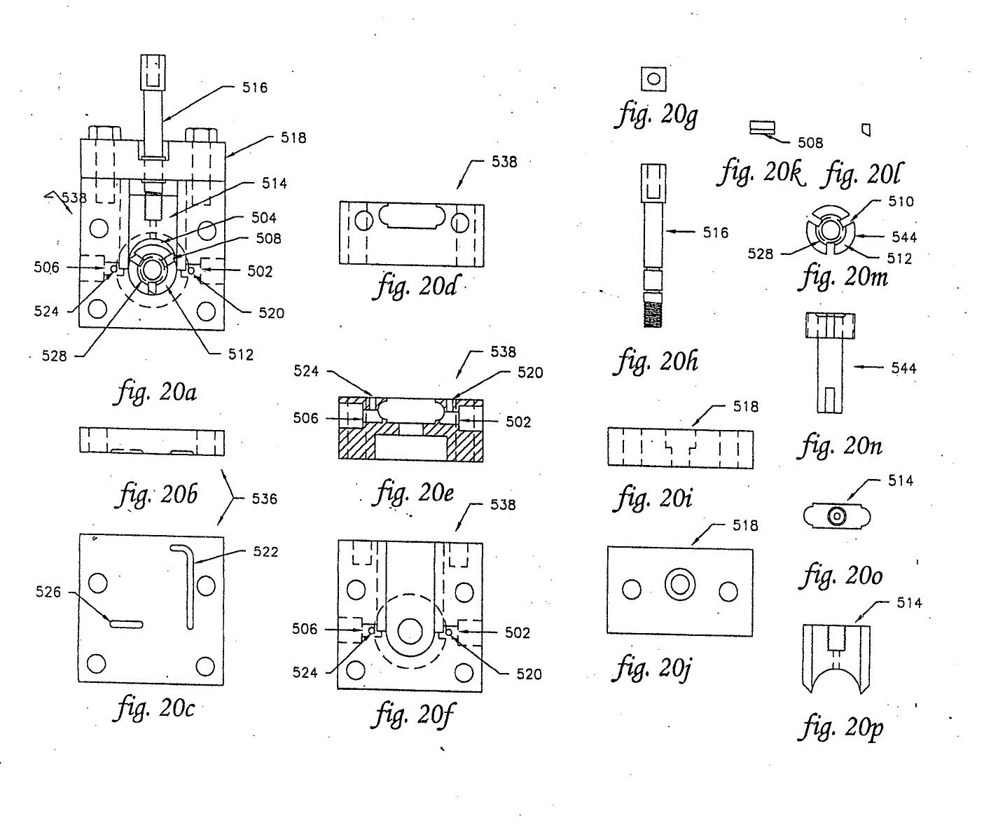

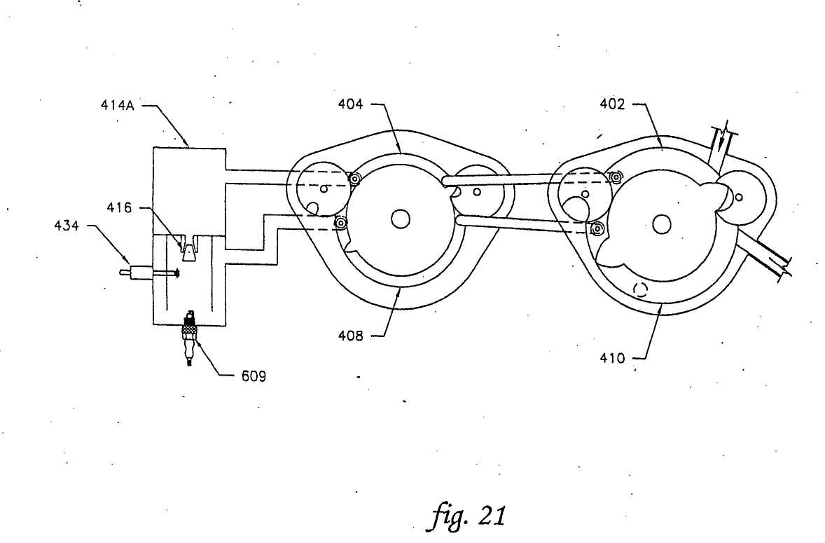

A view of the fuel pump 424 of FIG. 2 is shown in FIG. 20a, with a cover plate 536 thereof removed, for clarity, to reveal a pump block 538 which, in use, is bolted to the engine block in overlying relation to the end of a gate rotor shaft 316. The pump block 538 defines an inlet port 502, an outlet port 506 and a pump chamber 504. A keyed rotor 544 is shown in isolation in FIG. 20n. The rotor 544 extends through the pump block 538 into a keyed bore (not shown) formed in the end of the gate rotor shaft 316, and is secured thereto by a key (not shown). This provides for rotation of a rotor head 512 of the rotor 544 in the pump chamber 504 contemporaneously with rotation of the gate rotor shaft 316. Fuel enters through the inlet port 502, passes through the pump chamber 504 and exits through the outlet port 506. The fuel is swept through the chamber 504 by three moveable vanes 508 set in slots 510 in the rotor head 512. A throttle slide 514 is shown in isolation in FIGS. 20o, 20p. The slide 514 is fitted for sliding movement in a chase formed in the pump block 538. The volume of the pump chamber 504 is changed by moving the throttle slide 514 towards or away from the face of the rotor by means of screw threads on a,throttle shaft 516, which rotates in the end plate 518. The face of the throttle slide 514 is a partial cylindrical surface that matches the face of the rotor head 512. Thus, the volume in the pump chamber 504 can be reduced to zero when the throttle slide 514 is fully advanced. A passage 520 runs from the inlet port 502 to the top of the pump block 538 where it intersects an L-shaped groove 522 in the cover plate 536. This permits any fuel that might leak past the throttle slide 514 to be drawn back to the inlet port 502. A similar passage 524 at the outlet port 506 connects to a groove 526 in the cover plate 536. This supplies pressurized fuel to the circular groove 528 in the top of the rotor 544 thereby forcing the vanes 508 into contact with the face of the throttle slide 514.

With reference to FIGS. 1 and 9, the rotary device 200D of the air motor 408 is configured for operation as an expander, and is coupled to the tubular combuster 426 so as to be driven by the primary exhaust products to produce power and secondary exhaust products, removing a fixed volume of gas from the combuster 426 for each rotation of the shaft 314. In FIG. 9, fluid ports 208D are each shown coupled to a respective halve of combuster 426. The piston 204D of the rotary device 200D of the air motor 408 has four lobes 232D, and is similar in dimension to that of the second compression stage 404.

With reference to FIGS. 1 and 10, the rotary device 200E of the gas expander 410 operates as an expander and is coupled to the air motor 408 for receiving the secondary exhaust products and expanding same substantially adiabatically to produce tertiary exhaust products and power. The piston 204E of the gas expander 410 has four lobes 232E, and is wider than the rotors 204A,204B,204C of the compressor, so as to provide a greater expansion volume than compression volume in the engine 400.

The vacuum relief valves 422 are provided to permit communication between the atmosphere and the interior of the gas expander 410 when the interior pressure threatens to fall beneath atmospheric pressure, and communicate with the inlets 208E via respective vacuum ducts 425. The vacuum relief valves 422 of this preferred embodiment are constructed similarly to the aforementioned check valves 412 known to persons of ordinary skill in the art, and are for similar reasons not described in detail.

The shaft 314, which as aforesaid is shared by each of the compressor 428, the air motor 408 and the gas expander 410, will thus be seen to define power transfer means for directing power produced by the air motor 408 and the gas expander 410 in use to drive the compressor 428 and any external load.

In addition to the foregoing, an oil circuit is provided, in the form of an oil pump 700, shown in FIG. 2, which is coupled to a sump 714. Oil drawn from sump 714 is circulated through oil supply line 702 to distribution conduits 706 formed in the top of the engine 400, above the shafts 314,316, as shown in FIG. 4. Lubrication channels 708 in the housing plates 214A,B,C,D,E lead from the distribution conduits 706 to central bores through which, inter alia, the shafts 314,316 pass. Distribution heads 710 receive oil from lubrication channels 708, and direct flow longitudinally, against longitudinally-adjacent pistons 204. Distribution conduits 708 also feed bearings (not shown) for the gate rotor shafts 316. Additionally lower distribution conduits 706 are formed in the bottom of the engine 400, beneath the shafts 314,316. Also provided are additional lubrication channels 708 which collect oil from the bores, and, via drains 709, from longitudinally adjacent bearings, for delivery to the lower distribution conduits 706, and subsequent return to the sump 714, for reuse. A conventional oil cooler (not shown) is provided, and utilized as necessary to withdraw heat from the oil. The oil pump 700 shown in FIG. 2 is of similar appearance to the fuel pump previously described, but it should be understood that this is mere coincidence; any conventional oil pump may be employed.

Steady State Operation.

In operation at steady state conditions, the pressure in the radiator 414 and at the inlet of the combuster 426 is substantially constant. (Among other things, minor flow-induced pressure gradients may develop in the ducts and valves of the device, and periodic minor fluctuations in pressure may result from the manner in which compression takes place, namely, periodically.) It should be understood that this constant is not an absolute constant, but rather, varies with, among other things, the load being driven by the power transmitted by the shaft 314. Ambient air is drawn into the compressor 428 and forced into the radiator 414, in the manner described previously. It should be noted,at this time that the close spacing of the lobes 232C of the third compression stage 406 ensure that through a substantial portion of their sweep air is trapped between two lobes 232C moving in tandem, rather than between a gate rotor 206C and an approaching lobe 232C. Thus, the third compression stage 406 in this example functions both to add some compression, to prevent any back flow that would lead to pressure fluctuations in the radiator 414 and smooth pressure spikes. The mass of the air forced into the radiator 414 is a function of the rotational rate of the shaft 314, the volume swept by the lobes 232A in the first compression stage 402 and the ambient pressure and temperature. Similarly the mass of air leaving the combustor is a function of the rotational rate of the shaft 314, the volume swept by the lobes 232D in the air motor 408 and the pressure and temperature within the combustor. During steady state operation the two masses must be equal.

In contrast to a conventional piston-cylinder engine, air will not be compressed to any maximum compression set by the compressor before ingress to the compressor. Rather, since the chambers defined by the compressor 428 wherein pressurization is occurring are in fluid communication with the radiator 414 at all times, air will be compressed into the radiator 414 only against the pressure of the radiator 414. Air will issue from the radiator 414 at a mass flow rate equivalent to that entering the radiator 414, pass through the check valve 417 and to the inlet of the combuster 426, where it is mixed with fuel and combusted to produce primary exhaust products. The pressure in the combuster 426 will be substantially constant, although slight fluctuations may occur, from the manner in which expansion is accommodated, namely, periodically. This pressure will also be a function of, among other things, the load on the shaft 314, and will be marginally less than the radiator 414 pressure. The residence time of the fuel in the combuster 426 is such that most of the fuel is combusted, and the temperature is such that NOx emissions are relatively low. The primary exhaust products pass through the air motor 408, producing shaft power, and exit as secondary exhaust products. The secondary exhaust products are expanded substantially adiabatically in the expander 410 to produce tertiary exhaust products and shaft power. The secondary exhaust products exit the expander 410 near atmospheric pressure, such that most work has been extracted therefrom, and to reduce the need for resonators and mufflers. To the extent that there exists any excess expansion space in the expander 410, the vacuum relief valves 422 permit flow of ambient air into the expander 410, so as to avoid the creation of a vacuum.

Transitioning to New Loads

When transitioning from a relatively heavy load to a relatively light load, the fuel flow rate will be decreased, thereby to create less heat in the combuster 426, less increase in the volume of the air being heated and lower pressures. The lower pressure in the combuster 426 will increase flow from the radiator 414 until such time as the pressure in the radiator 414 has dropped to a point that it is only sufficiently great to force flow into the combuster 426 at the same rate as it is delivered by the compressor 428. The depressed radiator 414 pressure will result in relatively more air bypassing the second compression stage 404 and/or the first compression stage 402, with the result that less work will be exerted on the gas. It will thus be evident that the effective compression ratio of the engine 400 will spontaneously adjust downwardly in response to lower loads.

When transitioning from a relatively light load to a relatively heavy load, the fuel flow rate will be increased, thereby to create more heat in the combusters 426 and higher pressures. Again, fuel will be introduced into the tubular combuster 426 in a manner which will provide for substantially constant pressure. The higher pressure in the combusters 426 will temporarily decrease flow from the radiator 414, thereby resulting in a pressure increase in the radiator 414. The increased pressure in the radiator 414 will increase flow to the tubular combuster 426, and, to the extent that the pressure in the pressure tank 418 is below the radiator 414 pressure, will result in flow into the pressure tank 418. This situation will occur until a steady state is reached wherein the pressure in the radiator 414 has risen to a point sufficiently great to force flow into the tubular combuster 426 at the same rate as it is delivered by the compressor 428. The heightened radiator 414 pressure will result in relatively less air bypassing the first compression stage 402 and/or the second compression stage 404, with the result that more work will be exerted on the gas, to wit, enough to force the gas into the relatively higher pressure radiator 414. It will thus be evident that the effective compression ratio of the engine will spontaneously adjust upwardly in response to higher loads.

With regard to transitions to higher loads, stalling can occur in the context of rapid load increase, since constant flow to the engine would require a corresponding rapid increase in radiator pressure. To avoid this consequence, air can be released from the pressure tank 418 by opening the solenoid valve 420.

Pressurized air from the air tank 418 can also be used to start the engine, in the place of a conventional starter. With respect to starting, it should also be noted that, when the engine is not operating, the pressure in the radiator 414 and combuster 426 will be at or near atmospheric pressure. Accordingly, with the engine decoupled from any external load, relatively little force will be required to rotate the shaft 314 for starting, since much of the ambient air being drawn into the compressor 428 will not be pressurized to any great extent, and will pass more or less directly to the radiator 414, against very little back pressure, and therefrom, into the combuster 426, against very little back pressure.

Dimensions

The various components of the engine are constructed to meet the anticipated demands of the engine and the fuel upon which it will operate. In the context of an engine which will drive a constant load, the expansion volume will be sufficient to make proper use of the energy contained in the fuel, such that expansion gases contain very little energy. That is, the exhaust gases will exit at as close to atmospheric pressure as is practical. With respect to compression volume and ratio, this needs to be sufficient to meet the oxygen demands of the engine at the operating pressure.

If the range of the engine will not operate at constant loading, the normal operating range of the engine will need to be considered. At peak fuel load, the engine will operate at peak compression, and will need more expansion volume than when the engine is running under lower loads. Thus, an engine designed for an application requiring a narrow operating range should have a larger expansion to compression ratio than an engine designed for a wider operating range.

The incorporation of the vacuum relief valve 422 in the expander 410 helps to prevent unnecessary drag on the piston 204E when the engine 400 is operating at low fuel loads. However, for an engine that frequently operates under low load conditions, it may be desirable to strike a balance incorporating somewhat less expansion volume. For example, in an engine which is expected to operate under a wide load range, it may be desirable to have the expansion to compression ratio optimized for a 75% fuel load. Thus, when the engine is under peak load, the expansion volume will be somewhat inadequate. Conversely, when the engine is under low load, the expansion volume will be somewhat too large. Nevertheless, across the range of operating loads for that specific application, optimizing for a 75% fuel load could prove the best solution in terms of overall efficiency.

### Second Preferred Embodiment

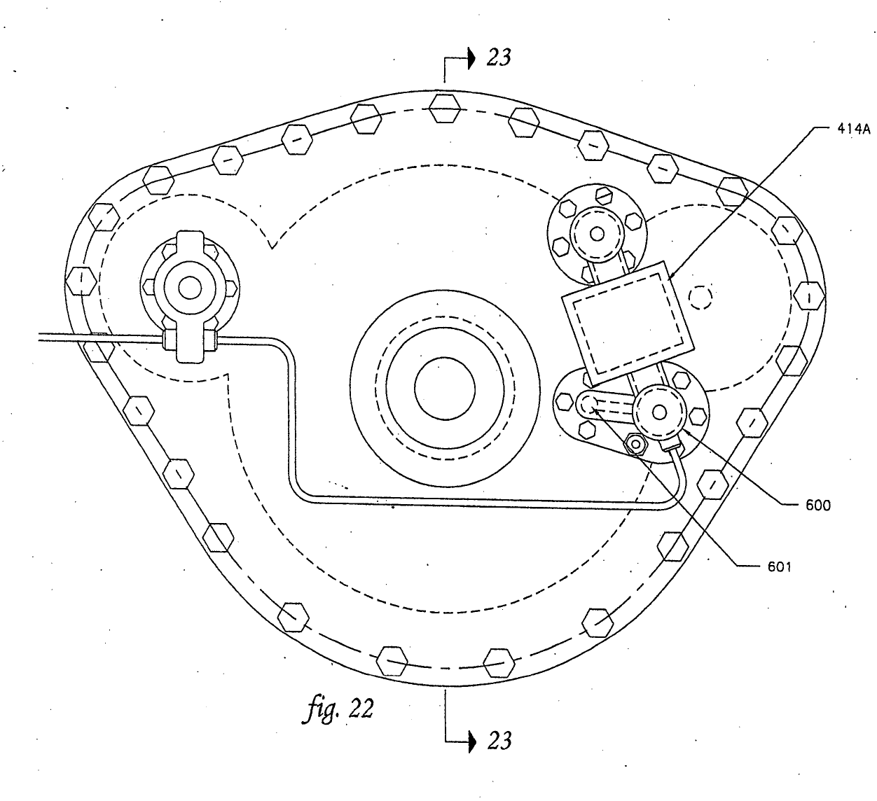

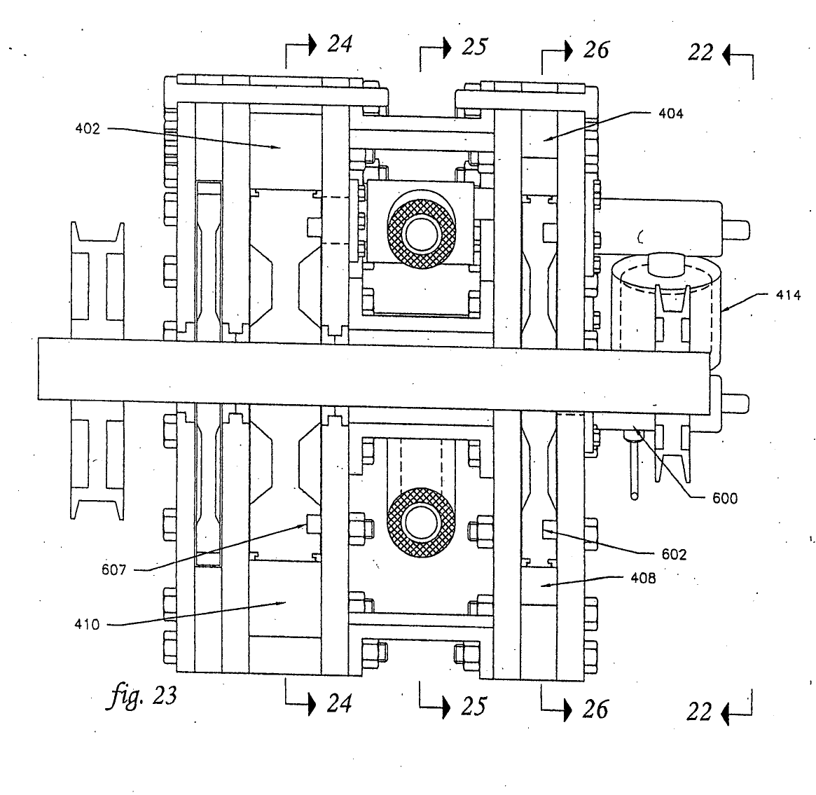

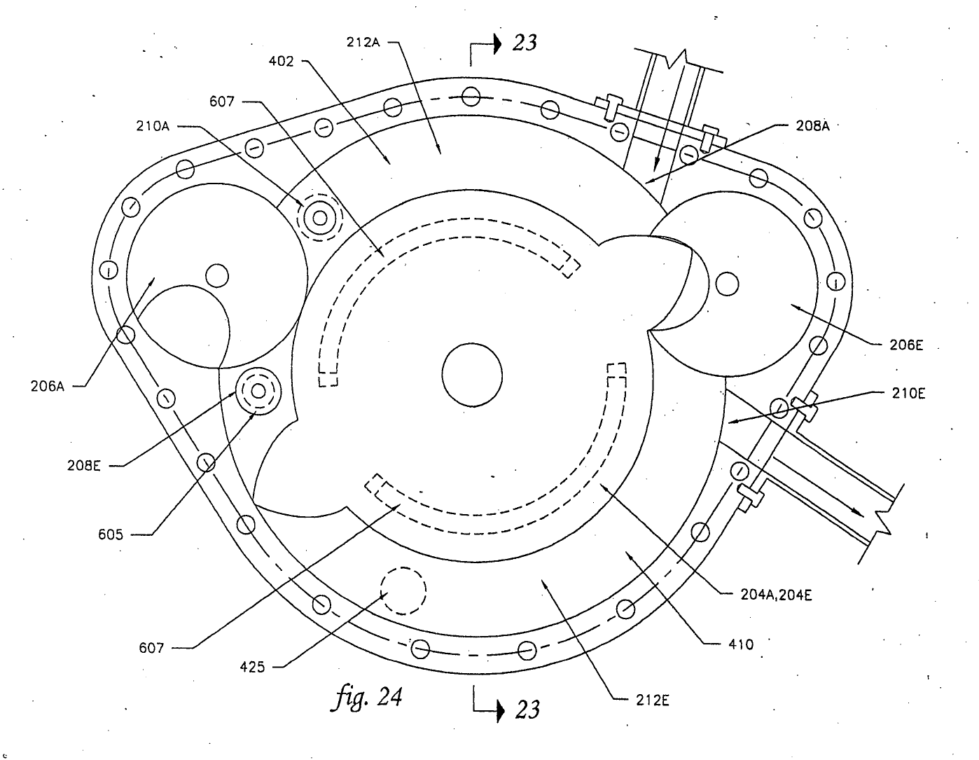

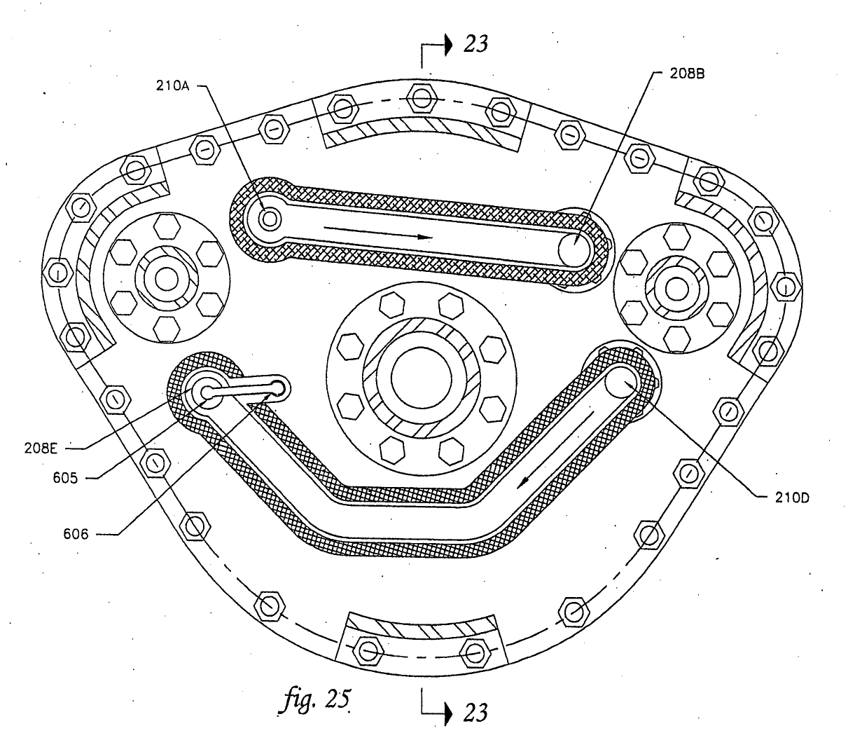

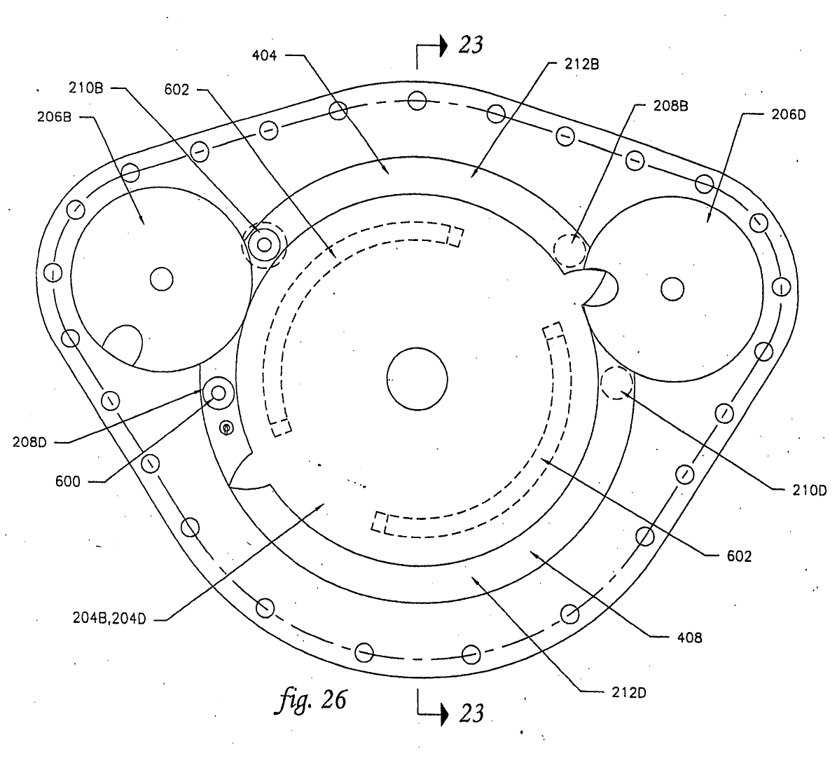

A second preferred embodiment of an engine according to the present invention is illustrated in FIGS. 21-26. Components of this engine which correspond to those of the first preferred embodiment are provided with identical reference numerals. As will be evident to persons of ordinary skill in the art, this engine is generally similar to that of the first preferred embodiment, and thus, a detailed description of its components and operation is neither needed nor provided herein. Rather, for simplicity, only the differences in structure and operation are herein set out.

From the standpoint of structure, this engine lacks a third compression stage, and includes only two pistons, in contrast to the previous embodiment, wherein five pistons were used. Further, wherein in the previous embodiment the gate rotors were disposed 180° apart from one another relative to the drive shaft, herein, the gate rotors are about 130° apart from one another, such that the chambers defined on either side thereof are not of equal volumes. As well, in this configuration, no external combuster is provided, and a simple reservoir 414A is provided in the place of the radiator. Additionally, an inlet valve/fuel injection port 600 herein is controlled by a lifter rod 601 which runs on an inlet valve control groove 602 in the second rotor. This mechanism forces the inlet valve/fuel injection port 600 closed while the lobe is passing through the gate rotor. The inlet valve/fuel injection port 600 in this example configuration is designed to introduce fuel to the first expansion chamber as well as compressed air. The inlet valve/fuel injection port 600 has a hollow valve stem (not shown) that rides over a valve stem centre pin (also not shown) that in turn has a central cavity extending almost to the first expansion chamber. Outlet ports in the valve stem and valve stem centre pin will only align when the inlet valve/fuel injection port 600 is open, allowing fuel to enter and mix with the incoming air. A glow plug 609, or spark plug, if appropriate to the fuel, is placed just downstream of the inlet valve/fuel injection port 600. A primary exhaust valve 605 coupled with a primary exhaust valve lifter 606 running in the second expansion chamber inlet valve control groove 607 controls the inlet to the second expansion chamber. This mechanism prevents combusted gases from entering until the gate rotor recess is clear of the chamber. This mechanism will also prevent the gases from escaping directly to the atmosphere when both the inlet and exhaust port are exposed.

In operation, air passing through this engine will enter a first compression stage 402, defined by the smaller volume side of the first piston, then proceed to a second compression stage 404, defined by the smaller volume side of the second piston. From the second compression stage 404 the compressed air flows through to the reservoir 414A, and thereafter to the larger side of the second rotor. Fuel is added directly into the chamber swept by the larger side of the second rotor and combustion takes place. Thus, the larger side of the second rotor serves as a combuster and as an air motor 408. The pressure in the combuster will rise on ignition forcing the inlet valve 600 to close. While the cam groove allows, and while the pressure in the reservoir 414A is greater than the pressure in the first expansion stage 402, this valve 600 will open and equalize the pressures. Thus, at low engine loads, with corresponding low fuel loads, the pressure in the first expansion stage will drop below the pressure in the reservoir 414A before the valve lifter reaches the end of the cam groove. In this case more air will flow from the reservoir 414A into the combuster 426. This will drop the pressure in the air reservoir 414A until a state of equilibrium is reached at a compression ratio between the minimum and the maximum.

While the invention has been described in connection with just two preferred embodiments, it will be understood by those skilled in the art that other variations and modifications of the preferred embodiments described above may be made without departing from the scope of the invention.

For example, compression and/or expansion could both be completed using a larger number of steps than indicated in the preferred embodiments.

As well, other non-rotary configurations of the engine are possible. By way of example, a first compression could be accomplished with a piston, with the air being piped to another location for secondary compression using a rotor. Similarly, the expansion can be multi-staged, employ different means from one stage to the next, with the various stages taking place in different locations.

Obviously the second preferred embodiment could be equipped with an external combuster as described in the first preferred embodiment.

The engine can be used with or without the pressure tank, depending on whether the application would have to respond to rapid changes in engine load.

The pressure tank could also be charged via a separate compressor mechanism. This separate compressor could be another rotor group on the existing main drive and gate rotor shafts, or an independent mechanism. In these cases, it becomes possible for the pressure in the tank to be higher than the maximum compression ratio of the engine.

Water in the combustion chamber could keep the heat of combustion from getting too high, and would provide additional expansion volume. Since the exhaust gases would typically undergo an adiabatic expansion to atmospheric pressure, it would be a simple matter to capture and recycle condensed injection water. Another option would be to inject the water during compression. The added heat sink effect of the water makes the compression more closely resemble an isothermal compression. This has advantages over an adiabatic compression in that the result is relatively cool dense air which is ideal for maximizing efficiency.

A small simple engine could be built using only a single pair of gate rotors working in concert with a single multilobe piston.

The engines of the preferred embodiments are capable of switching between a wide variety of liquid fuels without modification. Similarly, switching from one gaseous fuel to another should be relatively simple. However, modifications to fuel pumps and possibly injectors would likely be required to shift back and forth from liquid to gaseous fuels. Such modifications are known to persons skilled in the art, and as such, are not described in detail herein. Explosive fuels, may be used, provided fuel is introduced gradually. For slower burning fuels, fuel could be introduced in bursts.

From the above, it should therefore be understood that the scope of the present invention is limited only by the following claims, purposively construed.

1. An engine (400) for use with a load, said engine comprising:
a compressor (428) adapted to receive power and, upon receiving power, to: periodically define a chamber; fill the chamber with ambient air; and carry out a pressurization process wherein the chamber volume is decreased to produce pressurized air,
a radiator (414) adapted to receive pressurized air from the compressor (428) and to cool pressurized air so received,
combuster means (426) for receiving fuel and combusting same in a combustion process with the pressurized air to produce primary exhaust products,
a positive displacement air motor (408) adapted to be driven by the primary exhaust products to produce power and secondary exhaust products,
a positive displacement gas expander (410) for receiving the secondary exhaust products and expanding same substantially adiabatically to produce tertiary exhaust products and power, and
power transfer means (314) for directing power produced by the air motor (408) and the gas expander (410) in use to drive the compressor (428) and the load,
wherein:
the combuster means (426) is adapted to receive varying amounts of fuel, thereby to cause the power transfer means (314) to drive the load with varying amounts of power in use; and
the compressor (428) is adapted to, during the pressurization process, release air from the chamber for said combustion in a manner such that the pressure in the chamber during the pressurization process and the pressure of the primary exhaust products driving the air motor (408) is at a substantially constant level at steady state conditions, said level adjusting spontaneously to the load being driven by the power.

2. An engine (400) according to claim 1, wherein the compressor (428) is a rotary compressor.

3. An engine (400) according to claim 1, wherein the combuster means (426) comprises a tubular combuster.

4. An engine (400) according to claim 1, wherein the air motor (408) is a rotary air motor.

5. An engine (400) according to claim 1, wherein the gas expander (410) is a rotary gas expander.

6. An engine (400) according to claim 1, wherein the power transfer means (314) comprises a shaft operatively coupled to each of the compressor (428), the air motor (408) and the gas expander (410).

7. An engine (400) according to claim 1, further comprising a reservoir adapted to receive pressurized air from the compressor (428) and wherein the combuster means (426) receives air for said combustion from the reservoir.

8. An engine (400) according to claim 1, wherein the radiator (414) also serves as a reservoir adapted to receive pressurized air from the compressor (428) and wherein the combuster means (426) receives air for said combustion from the radiator (414).

9. An engine (400) according to claim 2, wherein the radiator (414) also serves as a reservoir adapted to receive pressurized air from the compressor (428) and wherein the combuster means (426) receives air for said combustion from the radiator (414).

10. An engine (400) according to claim 1, wherein the expansion ratio defined by the expander (410) is larger than the compression ratio defined by the compressor (428).

11. An internal combustion engine (400) for use with a load, said engine (400) comprising:
a rotary compressor (428) adapted to receive power and, upon receiving power, to: periodically define a chamber; fill the chamber with ambient air;
and carry out a pressurization process wherein the chamber volume is decreased to produce pressurized air,
a radiator (414) coupled to the compressor (428) to receive the pressurized air and adapted to cool said pressurized air and to function as a reservoir therefor,
a first backflow preventer (416) and a second backflow preventer (417), each coupled to the radiator (414) to permit unidirectional flow therefrom;
a pressure tank (418) coupled to the first backflow preventer (416) to receive pressurized air from the radiator (414);
a valve (420) coupled to the pressure tank (418) to permit the selective release of pressurized air from the pressure tank (418);
a tubular combuster (426) coupled to the valve (420) and to the second backflow preventer (417) to receive pressurized air from the radiator (414) and pressurized air selectively released from the pressure tank (418) and adapted to receive fuel and combust same in a combustion process with is the pressurized air so received to produce primary exhaust products,
a positive displacement rotary air motor (408) coupled to the combuster (426) so as to be driven by the primary exhaust products to produce power and secondary exhaust products,
a positive displacement rotary gas expander (410) coupled to the air motor (408) for receiving the secondary exhaust products and expanding same substantially adiabatically to produce tertiary exhaust products and power, and
a shaft (314) operatively coupled to each of the compressor (428), the air motor (408) and the gas expander (410) for directing power produced by the air motor (408) and the gas expander (410) in use to drive the compressor (428) and the load,
wherein:
the combuster means (426) is adapted to receive varying amounts of fuel, thereby to cause the shaft (314) to drive the load with varying amounts of power in use; and
the compressor (428) is adapted to, during the pressurization process, release air from the chamber for said combustion in a manner such that the maximum pressure in the chamber during the pressurization process and the pressure of the primary exhaust products driving the air motor (408) is substantially constant at steady state conditions, said constant being a function of the power driving the load.

12. An engine (400) according to claim 1, wherein the expansion ratio defined by the expander (410) is larger than the compression ratio defined by the compressor (428).

13. An engine (400) according to claim 1, wherein the compressor (428) is a three stage compressor.
